(19) United States
(12) Patent Application Publication
(10) Pub. No.: US 2002/0082910 A1
(43) Pub. Date: Jun. 27, 2002

(54) Advertising system and method which provides advertisers with an accurate way of measuring response, and banner advertisement therefor

(76) Inventor: Leandros Kontogouris, Neo Psychico (GR)

Correspondence Address: BACON & THOMAS, PLLC, 625 Slaters Lane, 4th Floor, Alexandria, VA, 22314-1176, US

(21) Appl. No.: 09/742,438

(22) Filed: Dec. 22, 2000

(51) Int. Cl. G06F 17/60

(52) U.S. Cl. 705/14

(57) ABSTRACT

An advertising system and method in which one or more banner advertisements are caused to appear when a user requests an electronic service or content is arranged to ensure a positive response and accurate measurement of the response by preventing access to an electronic address, service, or content unless the user correctly responds to the advertisement. Credits, such as reduced subscription rates, may be offered as an inducement for viewing the advertisement. The system and method may be practiced over networks other than the Internet, including wireless and interactive digital television networks.

### BACKGROUND OF THE INVENTION

1. Field of the Invention

This invention generally relates to the field of electronic commerce, and in particular to a banner advertising system and method which permits access to a selected electronic destination, or to services or content available at a selected electronic destination, only if a user of a network-connected computer or communications device responds in an appropriate manner to one or more banner advertisements, thereby ensuring that the banner advertisements have been read by the user.

The system and method of the invention provides advertisers with a convenient and accurate way of measuring response to an advertisement, enabling an electronic service or content provider to guarantee results and precisely calculate fees for displaying the advertisement, and thus further enabling the service or content provider to offer viewing of the advertisement as a quid pro quo for premiums such as reduced subscription fees, the reduced subscription fees in turn serving to attract new subscribers to the service or content provider's site while still maintaining a steady revenue stream.

2. Description of Related Art

According to the June, 2000 Internet edition of ZDNet News, advertising on the Internet reached $4.3 billion in 1999, and is expected to grow to $28.0 billion by 2005. Many websites and on-line businesses rely on advertising revenues as their sole income, while others utilize advertising revenues to support the offerings of free or discount goods or services necessary to attract users and build a brand-name.

Despite the importance of on-line advertising to the continued development of new on-line services and content, and therefore to the future of the new information economy, however, significant doubts have recently been raised concerning the viability of on-line advertising as a continued source of revenues. The same ZDNet article that predicted a 700% increase in advertising revenues over the next five years also cited evidence that conventional click-through “banner” advertisements are rapidly losing effectiveness. According to the ZDNet article, positive responses to click through advertisements had fallen from approximately 1% at the end of 1999 to less than 0.5% by June of 2000.

The decline in responses to click-through advertisements does not necessarily imply that other types of on-line advertising are also losing effectiveness, since the decline in responses to click-through advertisements may simply be a reflection of increased quality of content on popular sites, a decline in casual “surfing,” and the consequent increasing unwillingness to be distracted from content on sites that are being viewed by diversion to advertiser's sites. Nevertheless, the decline does lead to a loss of confidence in on-line advertising in general, and in particular in reduced advertising rates. Academic studies might show that some Internet advertisements in fact register in the minds of viewers even when the viewers do not click-through, causing the viewers to visit the advertiser's website at a later time, or influencing the decision to purchase an item or service through conventional channels, but such studies are difficult to perform and evaluate, and in general do not provide an advertiser with the confidence in the effectiveness of their particular advertisements provided by click-through numbers.

The loss of advertiser confidence resulting from the decline in click-through rates is certain to eventually result in lower advertising rates, decrease revenues, and even affect the availability of financing for new Internet start-ups, if it has not already. This eliminates many potential content providers and forces cutbacks in existing providers, the lack of which in turn reduces overall Internet usage, which further reduces advertising revenues. Given this deflationary spiral, one has to wonder whether the predicted growth in advertising revenues is at all realistic. What is clearly needed is a new way of presenting on-line advertisements, which provides a greater incentive to view advertisements than is possible with click-through advertisements, and yet which provides response “numbers” at least comparable in accuracy to click-through numbers, and which can be used as a precise measure on which to base advertising rates.

The full potential of the Internet as a way to provide information and services to a mass audience has barely begun to be realized, and may never be fully realized unless advertising can again be regarded as a reliable revenue source, permitting start-up concerns to build content and a brand-name, and providing steady revenues for existing concerns. Without such advertising, the very future of the Internet is in doubt.

The need to incorporate advertising as a source of revenue is at least as critical in the case of the emerging technologies of wireless digital communications or cellular telephony (i.e., the so-called “wireless web,” which use application protocol (WAP), universal mobile telecommunications system (UMTS), and other technologies to provide digital content similar to Internet “web pages” in a format suitable for display on miniature portable computing or communications devices), and interactive digital television (iDTV). Currently, these technologies rely on subscriptions, but if the availability of content and services is to expand at a rate comparable to the Internet, advertising revenues will also be required.

In the case of cellular telephone or wireless communications, the barriers to increasing the presence of advertising are greater than on the Internet. These barriers include the small size of wireless devices and their limited graphic capabilities, which reduces the appeal of advertisements, and the lack of consistent transmission and display standards and protocols, particularly in the United States. If premiums could be offered for viewing the advertisements, resistance to advertising on these networks would be greatly reduced, but the offering of premiums makes little economic sense in the absence of a reliable way to measure response. Click-through advertisements are even more difficult to implement on a portable device than in a conventional web browser and, given the nature of wireless use, which leaves users with less time to enter contests or apply for coupons, likely to have little impact.

Similar barriers to advertising exist in the case of interactive digital television. In addition to consumer expectations that subscription-based content will be advertisement free, one of the main obstacles to increasing the presence of advertising on interactive digital television is the technological infeasibility of click through advertisements. As indicated above, the lack of click-through capabilities makes it extremely difficult to gauge consumer reaction to an advertisement, reducing the incentive to place advertisements in the first place, and greatly reducing the fees that can be collected from advertisers.

In summary, a need exists to counter the declining effectiveness of conventional click-through advertisements and exploit the advertising potential of emerging technologies such as the wireless web and interactive digital television by providing a system and method for displaying on-line advertisements in a way that provides an accurate gauge of viewer response, the accurate gauge of viewer response in turn enabling advertisers to offer premiums such as reduced subscription fees for viewing the advertisements. The result of this effort should be an increase overall advertiser confidence, thereby supporting the expansion of content and services over the Internet as well as over the new wireless and interactive digital television networks, to the benefit not only of advertisers, but also of society as a whole.

### SUMMARY OF THE INVENTION

It is accordingly a first objective of the invention to provide an advertising system having a measurable response rate on which fees can reliably be based.

It is a second objective of the invention to provide an advertising system in which responses to advertisements can be accurately measured, both quantitatively in terms of numbers of viewers as well as qualitatively in terms of subjective viewer reaction to the advertisements.

It is a third objective of the invention to provide an advertising system which permits premiums to be offered in exchange for viewing advertisements.

It is a fourth objective of the invention to provide a system and method of offering advertisements in exchange for reduced or no-fee access to a subscription service or website, so as to encourage increased traffic without negatively affecting immediate revenues.

It is a fifth objective of the invention to provide a banner ad system suitable for increasing the potential viewership of a subscriber based site or service by offering discounts for those willing to view banner ads, and by providing a means for ensuring that those who chose this option in fact view the ads.

It is sixth objective of the invention to provide an advertising system having a measurable response rate on which fees can reliably be based, and yet which sends the viewer to a desired destination upon viewing the advertisement rather than diverting the viewer in the manner of a click-through advertisement.

It is an seventh objective of the invention to provide an advertising system and method suitable for use on the Internet, and which is easily adaptable for use in connection with wireless data communications, including cellular telephony, as well as interactive digital television.

It is a eighth objective of the invention to provide an advertising system and method which offers full screen advertisements easily visible on small-screen portable wireless devices.

It is an ninth objective of the invention to provide an advertising system and method which offers banner advertisements on a subscription or pay-per-view interactive digital television system without offending users.

It is a tenth objective of the invention to provide a new type of “banner advertisement” which fulfills the above objectives.

These objectives of the invention are accomplished by providing an advertising system and method in which one or more banner advertisements are caused to appear when a user requests an electronic service or content, and that prevents access to the electronic service or content unless a correct response to the banner advertisement or advertisements is registered.

The conventional definition of “banner advertisement” refers to advertisements that appear as a box on a web page display screen, that may contain text, images, animation, sound, video, and/or other effects, and that includes hyperlinks to the advertiser's website. However, those skilled in the art will appreciate that the term “banner advertisement” as used herein is not intended to be limited to advertisements that include hyperlinks to the advertiser's website, or to advertising on the Internet, but rather is intended to apply to advertisements in a variety of sizes relative to the display screen, that may include a variety of interactive features, and that may appear in connection with any electronic medium or network, including wireless and digital television media or networks, that permits interactivity between the user's computing or communications device and remote service or content provider.

The one limitation on the definition of banner advertisements as used herein is that the banner advertisements must be “interactive,” i.e., that the banner advertisement provide for input of a response indicative of whether the banner advertisements have been read. Upon input of a “correct” response, i.e., a response that meets predetermined response criteria, to each banner advertisement displayed, the user is connected to or permitted to access the requested service. The correct responses are tabulated for use as a basis for determining payments by advertisers, and preferably also used as the basis for awarding the user a premium for viewing and correctly responding to the advertisements. The premium may be in the form of credits applied against subscription fees for the requested service, or any other “premium” such as time credits on access charges to an Internet service provider or cellular telephone service, electronic coupons, free downloads, and so forth.

Implementation of the above-described system and method may take numerous forms. For example, in the case of an Internet connection, advertisements may be supplied by a server at the electronic address of the requested service, by a proxy server called by client software installed on the user's computer, by any computer situated between the user's computer and the content or service provider, including Internet service provider (ISP) or network operation center (NOC) servers, or by multiple sources. Client software installed on the user's computer may be in the form of a Java or Active-X file downloaded during a session, built-in to the user's browser software or operating system, or a plug-in to the user's browser software. The client software may be necessary to display the advertisements, or the advertisements may be displayed using existing software, and in either case, the client software may also inform the advertisement server of the configuration of the user's computing device. Cookies, electronic activity detectors in general, or other means of gathering information about the user may also be used to select or configure advertisements and determine the types of responses required.

The required response to a particular advertisement is preferably designed to ensure that the user has read the advertisement and to provide a meaningful gauge of viewer reaction on which advertising revenue can be based. It may, for example, consist of responses such as naming of products, answering questions, performing interactive game-like tasks, timing-related responses in which the user activates an input device when a correct response is displayed, and so forth, using a keyboard, mouse, or microphone, or other peripheral data input device. The system and method of the invention are applicable not only to Internet-based banner advertisements and pop-ups, but also to electronic destinations that offer services through interactive digital television, and wireless systems such as those that use the Wireless Application Protocol (WAP) which provide streamlined access to Internet sites through a wireless network.

It will of course be understood by those skilled in the art that the system and method of the invention may desirably provide for positive user consent before installation of any client software, including opt out provisions and full disclosure of the number of advertisements and nature of responses that might be required. In exchange for providing advertisers with useful information on response to their advertisements, users must be provided with sufficient rewards to overcome the inconvenience of having banner advertisements block access to a desired service or electronic destination. It may, however, be that access to the service itself is sufficient reward for viewing the advertisements, in which case a credit/award system may not be necessary. On the other hand, the system of the invention may be applied to multiple services from different providers at different addresses, sites, or locations, in which case a credit system that can be applied by an individual to any one of the numerous available services or destinations may be used.

Additional optional features of the invention include provision for the ability to click-through from the banner ad directly to the electronic address of the advertiser rather than the originally intended electronic address, the ability to store ads or their respective links in a favorites folder, and the ability to give users the choice to defer viewing ads for a subsequent moment and thus complete the transaction at a later time when credit for viewing the ad will be passed on to the user, or to accumulate credits in advance by viewing ads in blocks before seeking access to an electronic address, service, or content to which the credits will apply. Such a system would not only permit the user to determine credit usage, but also allow a user preference file to be collected that can be used by multiple services or sites. In that case, users may also be afforded the opportunity to by-pass use of the system and method with respect to certain destinations so as to avoid having to view banner advertisements in favor of direct access.

### BRIEF DESCRIPTION OF THE DRAWINGS

FIG. 1 is a schematic diagram of an advertising system arranged according to the principles of a preferred embodiment of the invention, showing a request for service/content/destination.

FIG. 2 is a schematic diagram of the system of FIG. 1, showing display of banner advertisement.

FIG. 3 is a schematic diagram of the system of FIG. 1, showing a successful response by the user.

FIG. 4 is a schematic diagram of the system of FIG. 1, showing connection to the service/content provider.

FIG. 5 is a schematic diagram of a variation of the system of FIG. 1, implemented without using a proxy.

FIG. 6 is a flowchart of an advertising method arranged according to the principles of the invention for use with the systems of FIGS. 1-4 or 5.

FIG. 7 is a flowchart showing a specific embodiment of the method illustrated in FIG. 6.

FIG. 8 shows a log-in screen for use in connection with step 220 of the method of FIG. 7.

FIG. 9 shows an information screen for use in connection with step 250 of the method of FIG. 7.

FIG. 10 shows a preferences screen accessible from the information screen illustrated in FIG. 9.

FIG. 11 shows an interactive banner advertisement for use in connection with step 270 of the method of FIG. 7.

FIG. 12 shows a pop-up response option menu for the interactive banner advertisement of FIG. 11.

FIG. 13 shows an account activity screen accessible for the information screen illustrated in FIG. 9.

FIGS. 14-21 show further examples of interactive banner advertisements for use in connection with step 270 of the method of FIG. 7.

### DETAILED DESCRIPTION OF THE PREFERRED EMBODIMENTS

FIGS. 1-4 shows a banner advertising system intended to illustrate, without limitation, the principles of a first preferred embodiment of the present invention. FIG. 5 shows a variation of the system of FIGS. 1-4.

The system illustrated in FIGS. 1-4 is particularly applicable to the Internet, and permits access to a selected electronic destination, or to services or content available at a selected electronic destination, only if a user of a network-connected computer or communications device responds in a predetermined manner to one or more banner advertisements, thereby ensuring that the banner advertisements have been read by the user. It includes a user's computing device 1, client software 2, an advertising server 3, and a service/content provider 4.

In the system illustrated in FIG. 1, the user's computing device 1 is connected to the advertising server 3 and service/content provider 4 over the Internet, with the advertising server 3 and service/content provider 4 also being connected to each other over the Internet. Alternatively, it is also possible for the advertising server 3 and service/content provider to be connected to each other over a closed network, or even for a single server to provide access to the content/service as well as serving the advertisements. For example, in the variation illustrated in FIG. 5, the advertising server is replaced by a gateway server 3′ that supplies the banner advertisements and controls access to the service/content 4′. On the other hand, it is also possible for multiple servers to separately handle serving of advertisements, tallying or evaluation of responses, accounting, and so forth.

In addition, as also illustrated in FIG. 5, the computing device 1 of FIGS. 1-4 may be replaced by a variety of other computing or communications devices. Elements 1′ in FIG. 5 are intended to represent the wide variety of potential users of the system of the invention, which may be applied not only to the Internet, but also to the so-called “wireless web” and the numerous computing and communications devices currently available or proposed for use on wireless networks, including WAP, UMTS, 3G, GPRS, GSM, CDMA or PCS devices, and so forth, as well as iDTV devices. The proliferation of standards and protocols for such devices and networks makes it impossible to list them all, but the it will be understood that the invention may be applicable to any such system, network, protocol, and so forth that supports two-way communication of digital data, and possibly even communication of data in formats other than digital.

Returning to FIG. 1, the system of the invention initially submits a service request over the network. The service request may be a request to connect with a server at a particular electronic address or, in some cases, simply a request for a particular service or content to be handled by an indeterminate server or server with the lightest load. For example, in the case of the Internet, the request may be a uniform resource locator (URL) submission to an Internet service provider, while in the case of a cellular system, the request may simply be a telephone number. On the other hand, in the case of a thin client or application service provider (ASP) system, the request may be a request to a directory service for a particular word processing, spreadsheet, personal information manager, or database program, which might be available on a variety of servers at different locations selected by the directory, or the request might be for a particular video movie or song in the case of an interactive digital television network.

In this embodiment of the invention, the service or content request is initially handled by a browser or client on the requester's computing device. Depending on whether the interactive banner advertising function is to be invoked, as will be described in more detail below, the client either sends the request directly to the electronic destination 4 (or along a path that will eventually lead to the destination) to connect the requester to the service provider, or the request is sent to banner advertising server 3 (which may, as indicated above, be the same as the electronic destination, i.e., the banner advertising server may be related to the service provider and connected through the same address, or may be an entirely separate proxy server to which the browser or client diverts the service request).

Depending on the type of network and computing or communications device, the client software 2 that handles functions specific to display of the banner advertisements may be an integral part of the above-mentioned web browser or other communications program, a separate program pre-installed on the user's computing device, an applet that is downloaded at the time the destination/service/content request is made, an agent of the user's ISP or gateway, or an agent of the content/service provider. In the specific case of a Windows™ Internet application, the client software 2 may be in the form of a Java or Active-X applet, or a browser plug-in. In addition, the client may be present on a directory service, network server, or other remote computing device, and/or different functions of the client may be distributed over single or multiple computing devices at either end of the intended communication. Whatever its form, and wherever it is installed, the client software performs any tasks necessary to display the advertisements received and facilitate response to the advertisements, including diversion of the initial service call to the advertisement server 3 if the advertisement server is a proxy server, checking configuration of the user's computing device if necessary, handling preferences, and so forth.

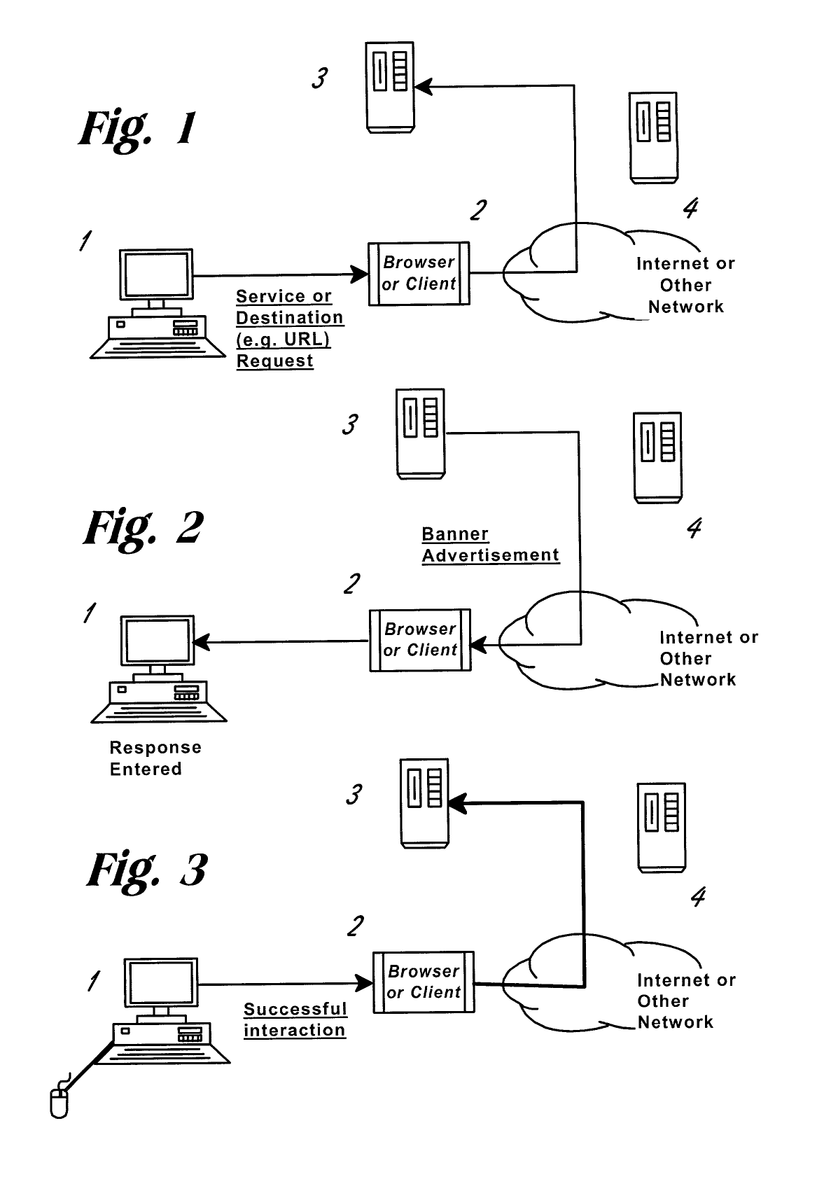

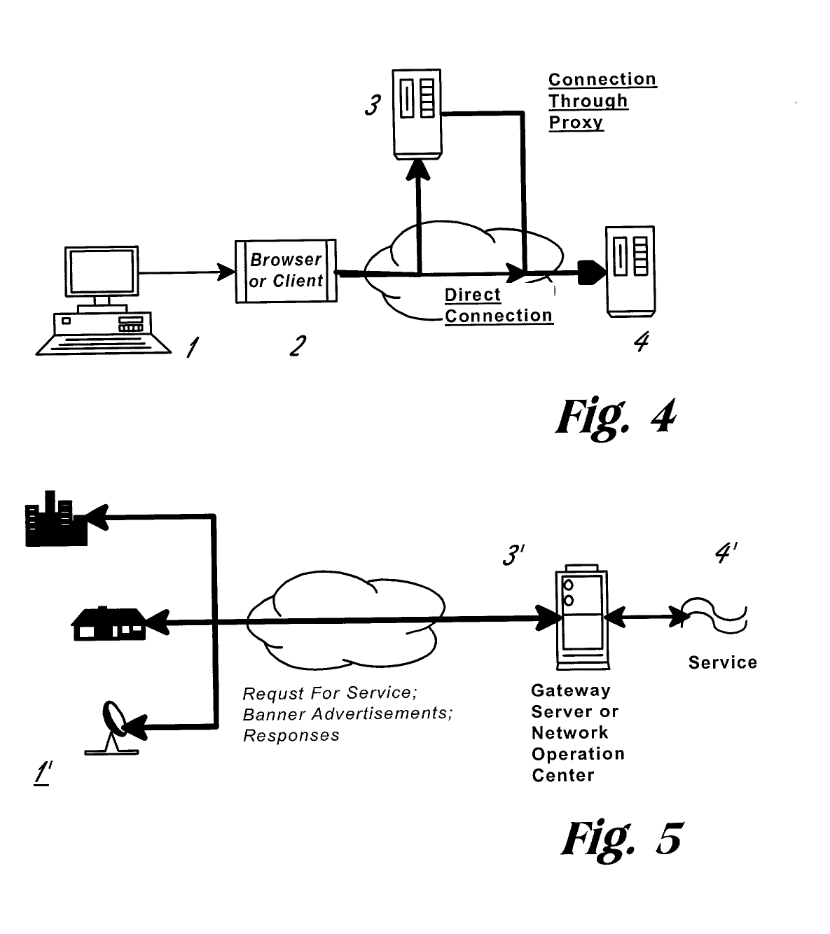

As illustrated in FIG. 2, when the service request is received at the banner advertisement server 3, the banner advertisement server sends a banner advertisement to the requester's computing device. Included or associated with the banner advertisement is a form or input area that permits input of information by the requester. Once the user has entered a reply, as illustrated in FIG. 3, the reply is forwarded to the advertisement server. Upon determination that the reply is adequate or appropriate, as illustrated in FIG. 4, the user's computing device 1 may be connected by the advertising proxy server 3 to the service/content provider 4, the client software 2 is permitted to be connected directly to the service/content provider 4, or the banner advertisement may simply be removed from the display so as not to interfere with a previously established connection to the service/content provider. In the case of the embodiment of FIG. 5, the gateway server 3′ supplies the service or content 4′ to the user's computing or communications device through the appropriate wired or wireless network.

The requested reply may in general be any information that requires the requester to view the advertisement in question, such as answers to queries concerning the advertisement, naming products presented in the advertisement, performing interactive game-like tasks, responding to timing-related queries in which different possible responses are presented at different times and the user activates an input device when a correct response is displayed, and so forth. The nature of the query and the manner in which it is answered will depend on the nature of the medium, products, and intended audience. For example, the query may require selection by a mouse click of a specific answer to a multiple choice question, or may require the requester to type in the answer, use a mouse or stylus to draw a shape or logo, or even give an oral answer using a microphone. In the case of a client resident on the requester's computer, or downloaded to the requester's computer upon requesting access to a particular address, the client may determine the peripherals available for the requester and configuration query accordingly, or inform the advertisement server so that the banner advertisements can be configured accordingly.

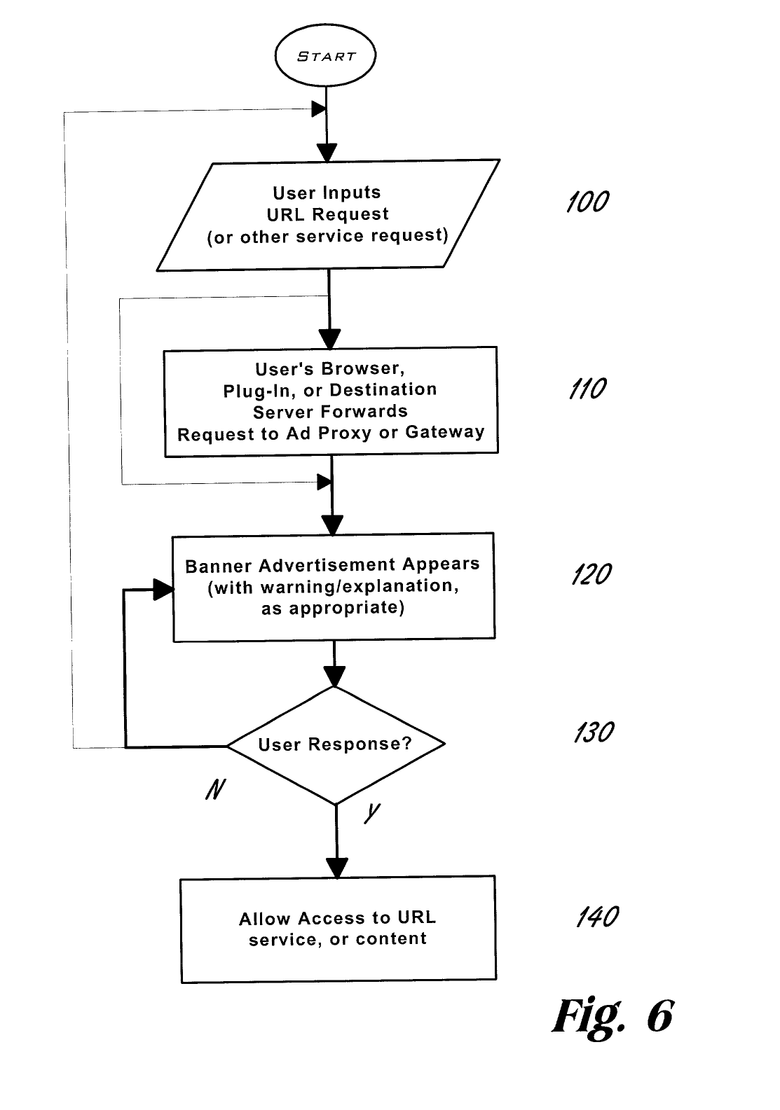

The method steps implemented by the system of FIGS. 1-5 are summarized in FIG. 6. First, the user inputs a request for connection to a particular electronic address, or access to a desired service or content (step 100). Next, in the case of a proxy advertising server, the request is forwarded to the advertising server (step 110). In some systems, the request may reach the destination server first, and then be forwarded to the advertising proxy, or the proxy step may be entirely eliminated and the method may, after the request has been sent and received, directly display one or more interactive banner advertisements (step 120). If the user responds correctly to the interactive banner advertisement as determined at step 130, the method of the invention allows access to the electronic address, service, and/or content (step 140). If not, the method of the invention may simply continue to display the advertisement until the browser or communications program is exited, the method may return to start, or the method may take some other action such as helping or prompting the user to enter the correct information, so long as the method does not permit access to the requested address, service, or content.

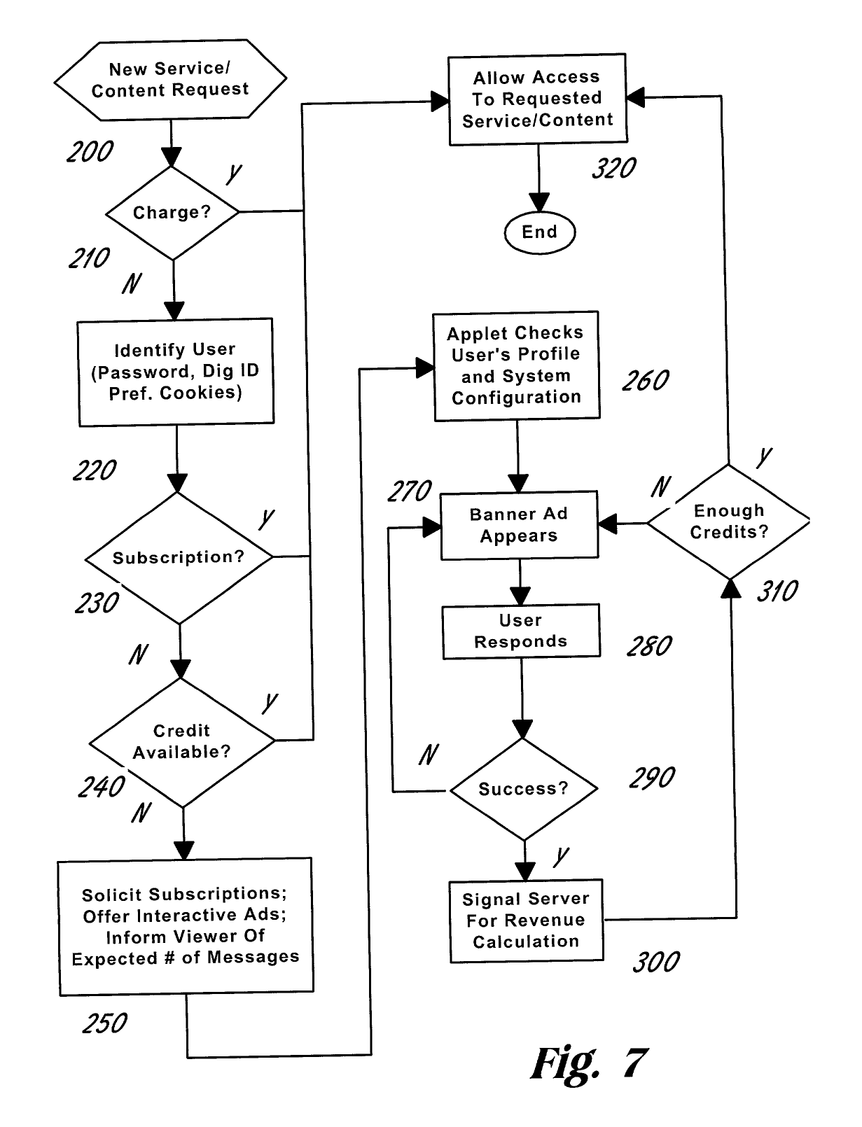

In the embodiment illustrated in FIG. 7, the method and system of the invention are associated with a subscription service, which permits the user to access the service upon viewing and correctly responding to the banner advertisements in lieu of a subscription payment, or in return for credits that can be applied against the subscription.

It will of course be appreciated by those skilled in the art that rewards or inducements for users of a network to install the client software or otherwise register for or participate in the interactive banner advertising system and method of the invention may take any of a variety of different forms other than reduced or free subscriptions to a website or other electronic address, service, or content. For example, in the case of a thin client application service provider or other content provider, the reward may be in the form of usage or time credits, or free or reduced price content, while in other situations the reward might be electronic coupons or even conventionally mailed coupons or prizes. If the system of the invention is offered by a credit card company, the rewards may take the form of cash-back or discounts, or the rewards may be in the form of frequent flier miles, or the like.

The first step according to the method of FIG. 7 is for the user to request connection to the electronic address of the subscription service (step 200), and for the user's browser or communications software, or a client program to which the browser or communications software directs the request, to intercept the request and send it to a proxy or gateway server. As illustrated in FIG. 7, the electronic address is in the form of a URL, although the invention is not limited to a particular type of electronic medium, address, or service.

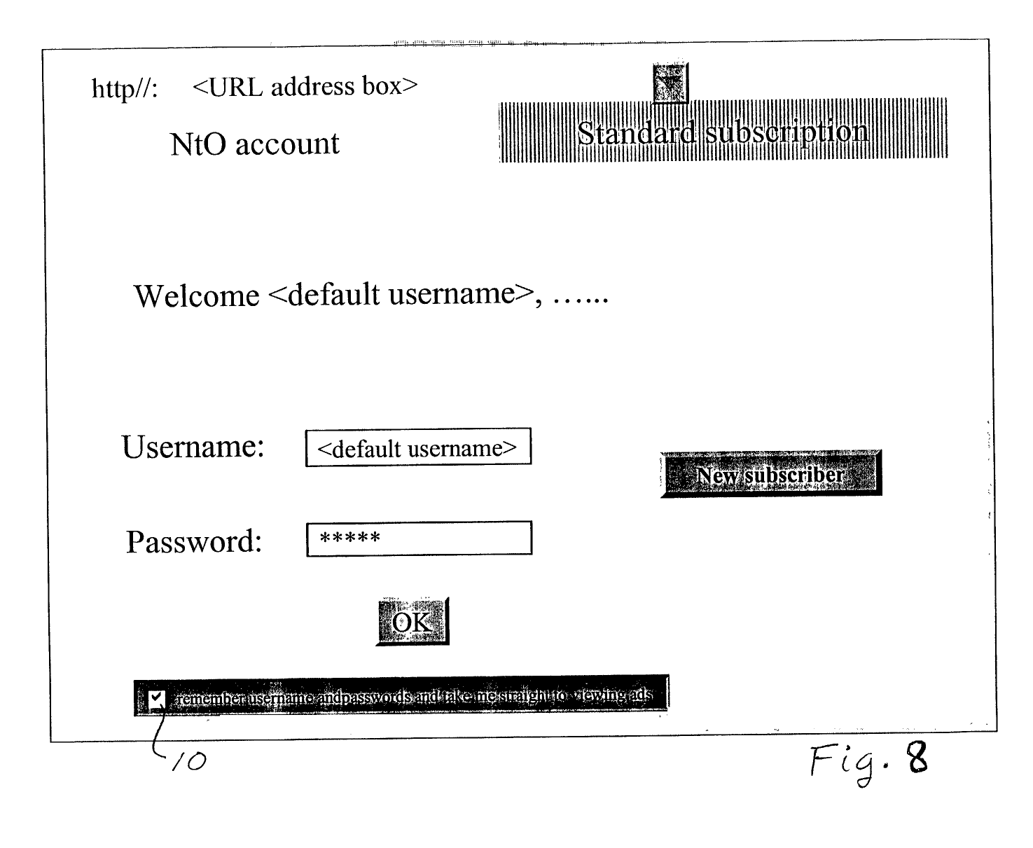

Upon receiving the request, the proxy or gateway server determines whether the service requested is one for which there is a charge (step 210). If not, the user is permitted to access the requested URL. If there is a charge, then the client identifies the user, either by presenting a log-in screen requesting identification by the user, for example by inputting a name and password as illustrated in FIG. 8 (step 220), or based on pre-stored log-in or registration information, assuming that the user has previously selected an option block 10 of the log-in screen (shown in FIG. 8) which registers the user's consent to storage of the registration information. In addition, the client may at this time gather “cookies” or pre-stored preference information on user preferences and use them to configure the display options or send them to the server that generates or selects the appropriate banner advertisements based on user identification and preferences.

Upon identification of the user, the server determines whether the user has a subscription that permits access to the service or content, e.g., to the requested web page, without having to view any advertisements (step 230), in which case the user is afforded access to the service or content. If the user does not have an unrestricted subscription, the method checks whether the user has already viewed enough advertisements, and therefore obtained sufficient credits, as explained below, to permit immediate access to the service or content (step 240), in which case immediate access to the content or service.

If the user does not have sufficient credits, then an information screen is presented to the user (step 250). Using the information screen, the user may optionally be offered a subscription which provides immediate access to the service, and/or offered the opportunity to view a certain number of interactive advertisements in order to access the service. Alternative to offering a subscription or offering the opportunity to view advertisements, the server may simply begin serving the interactive advertisements upon indication that the user still wishes to proceed access the requested service or content, for example by pressing a proceed button 20. The server may also begin to serve the interactive advertisements without obtaining immediate consent of the viewer, either on the basis that the viewer had previously been informed that this would happen upon attempting to access a particular service without a subscription, possibly upon being provided with the client software, or on the assumption that the interactive advertisements are sufficiently entertaining and related to the content of destination service or content that the viewer will not object to their presence (for example, children's television site might present entertaining interactive advertisements for related toys on the assumption that the user will welcome the advertisements even without prior warnings or indications of user intent to proceed).

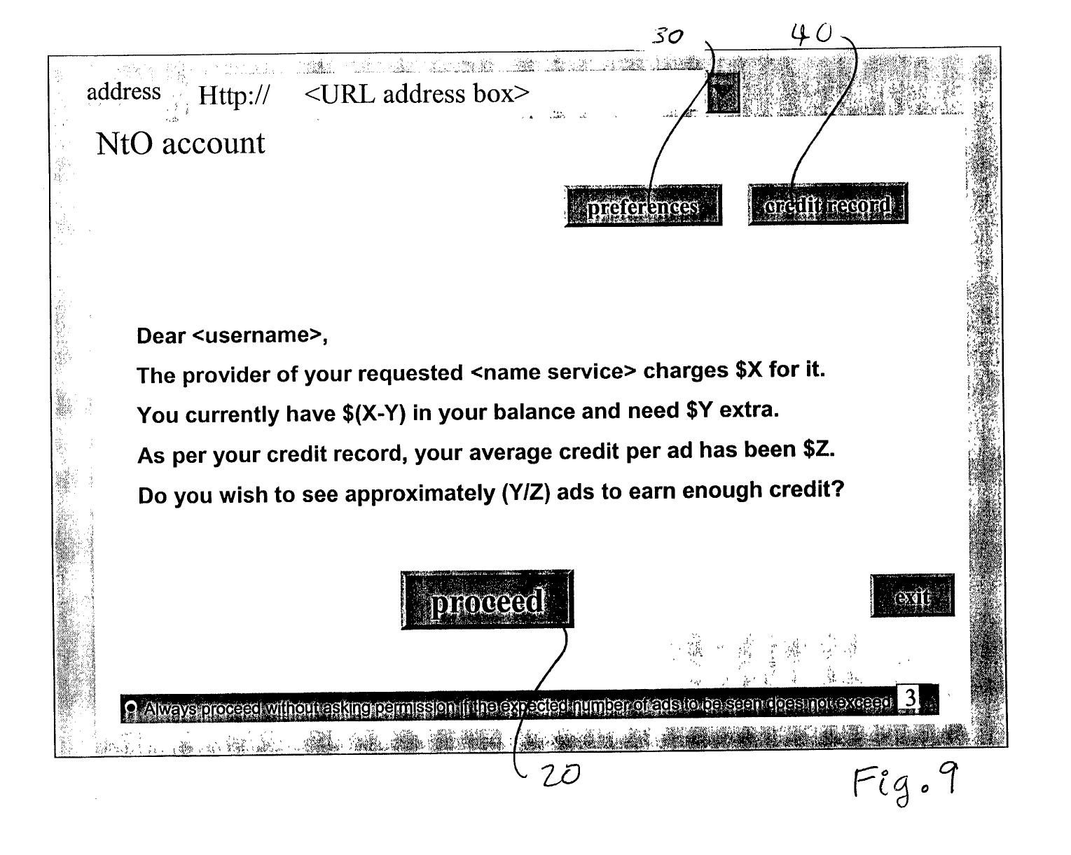

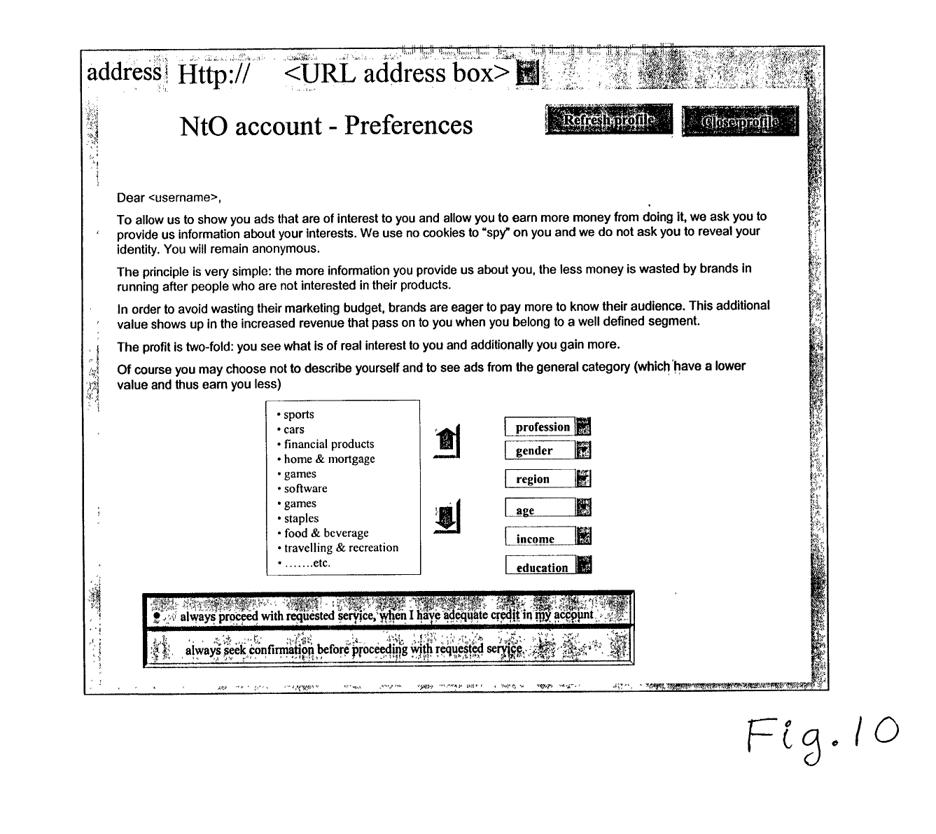

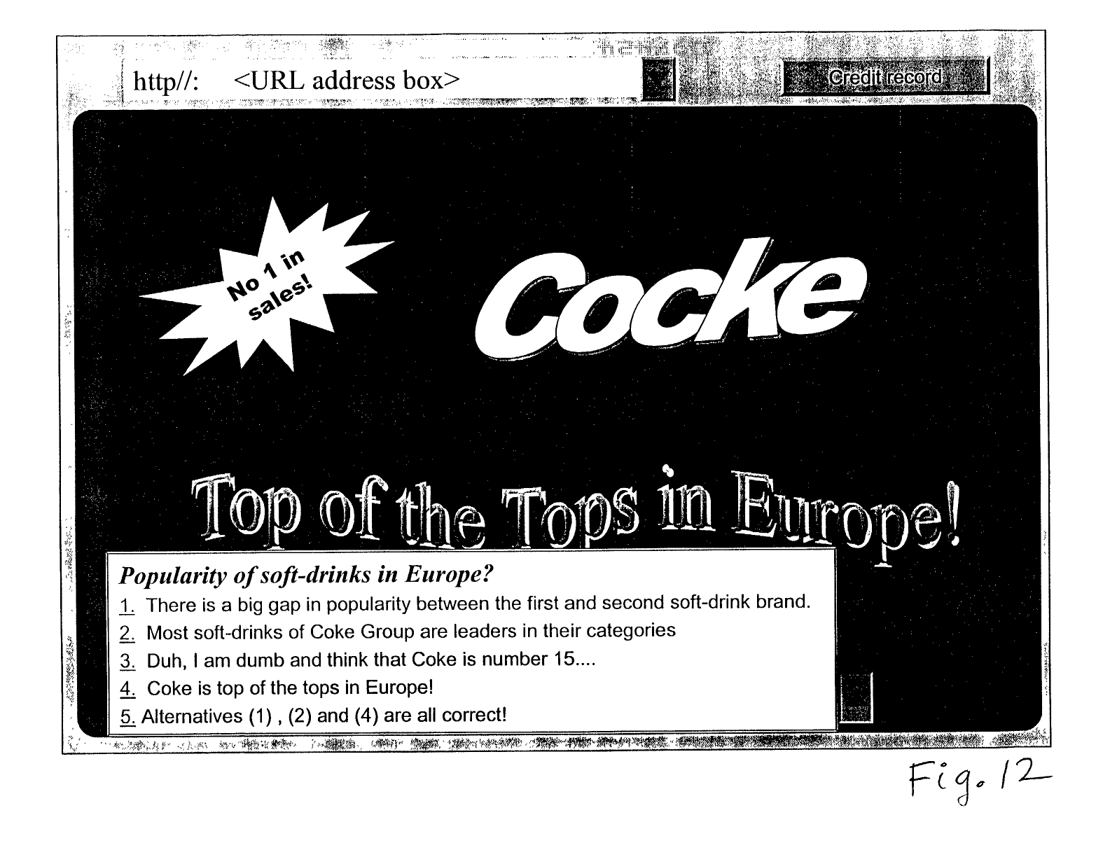

The information/proceed screen shown in FIG. 9 may also include buttons 30 and 40 for respectively permitting the user to enter or view preferences as illustrated in FIG. 10, and a record of accumulated credits, as illustrated in FIG. 13, and described later in this specification. The preference screen illustrated in FIG. 10 is an optional feature that permits a user of the system to input information or preferences that can be used to select the interactive advertisements that are sent to the user, rather than relying on cookies or other electronic activity detectors, or more surreptitious information gathering activities. As a further inducement for entering information through the preferences screen, the user may be given increased credits for every advertisement correctly responded to, or other rewards or premiums.

Following display of the information screen as described above (step 250), the user may be provided with an appropriate client applet, if the client applet has not already been installed, so as to enable the client to view and respond to the interactive advertisements. The applet will, as necessary, check the viewer's profile and system configuration (step 260). Following the check, if necessary, of the user's profile and/or system configuration, the method illustrated in FIG. 7 proceeds to the step of displaying one or more interactive banner advertisements, an example of which is illustrated in FIG. 11 (step 270). In this embodiment, which is implemented on the Internet, the banner advertisement may take-up a full screen or window in the user's browser, may hide a portion of the webpage whose address has been requested, or even may move around on the display screen, and may include any combination of text, graphics, video, sound, and/or animation.

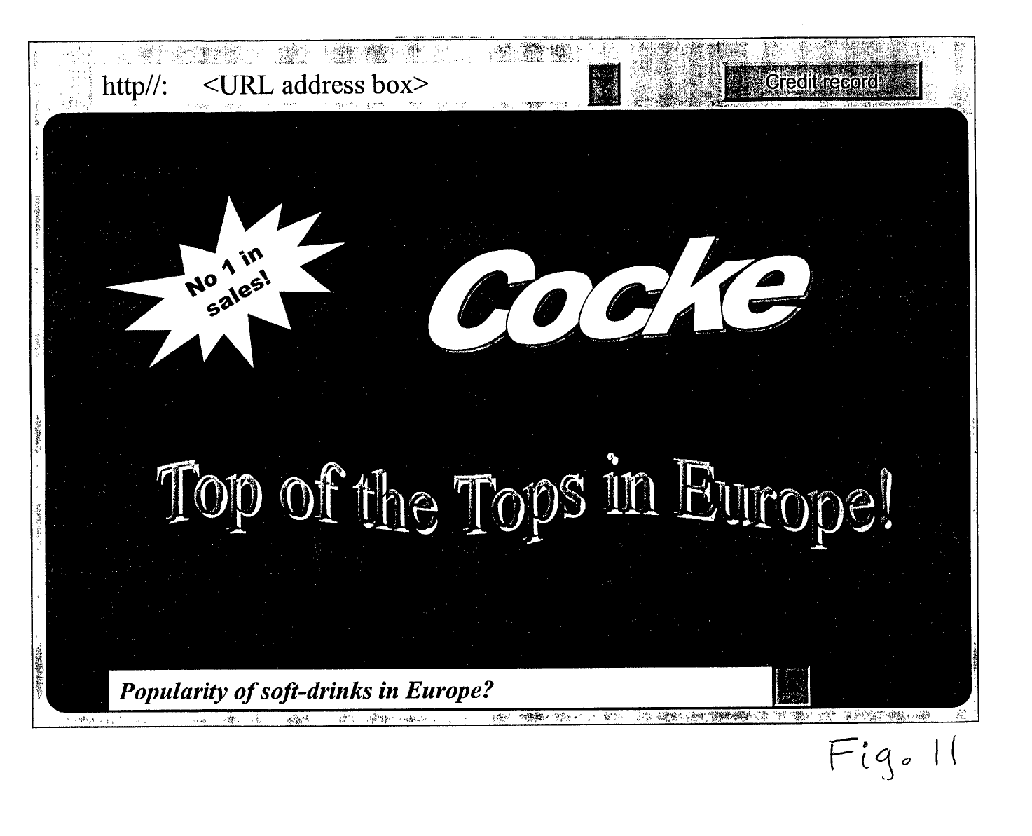

The system continues to display the advertisement until the viewer responds appropriately or, if given the option, cancels the service request. In the case of the banner advertisement illustrated in FIG. 11, the user must initially respond by popping-up an answer menu, illustrated in FIG. 12. The answer menu may include one or more correct answers, which preferably refer to information that will become apparent to the user upon reading or paying attention to the advertisement (or, in some cases, the questions may be ambiguous enough to force the user to have to think about the answer rather than passively view the advertisement).

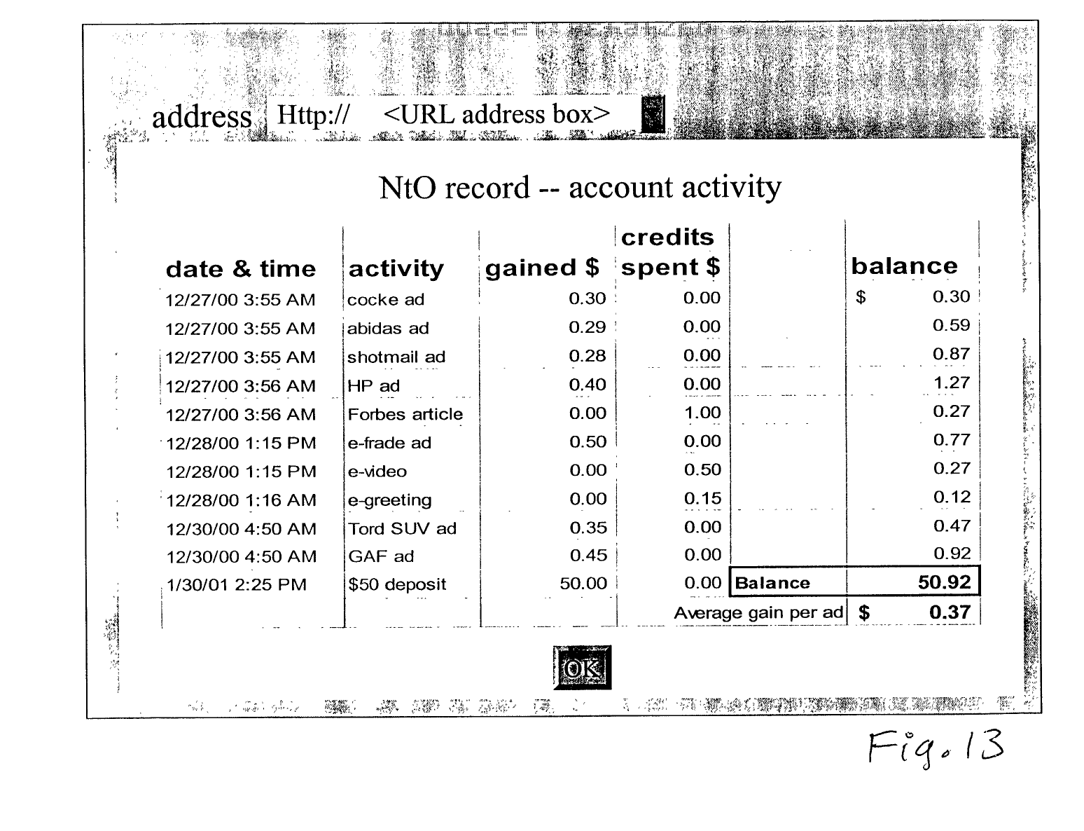

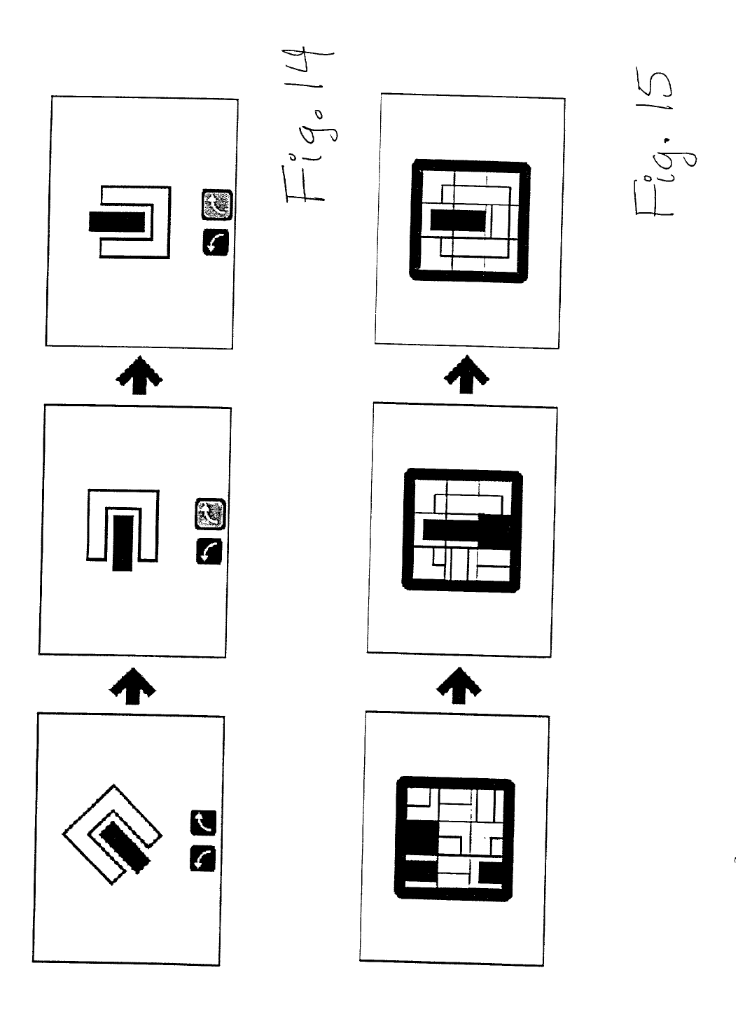

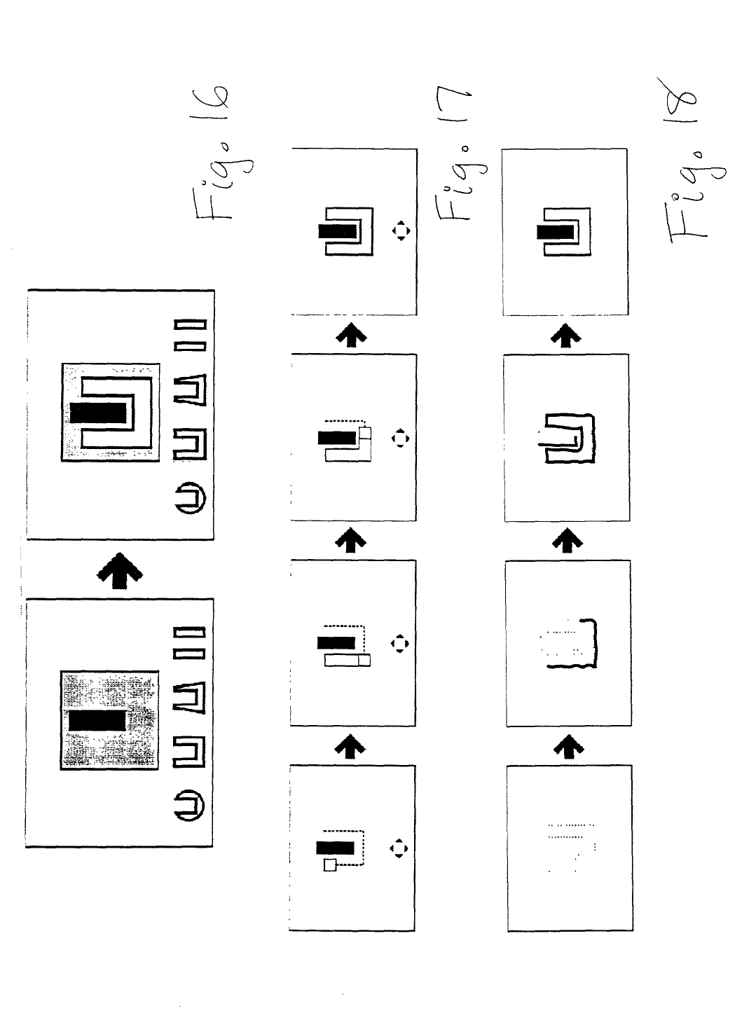

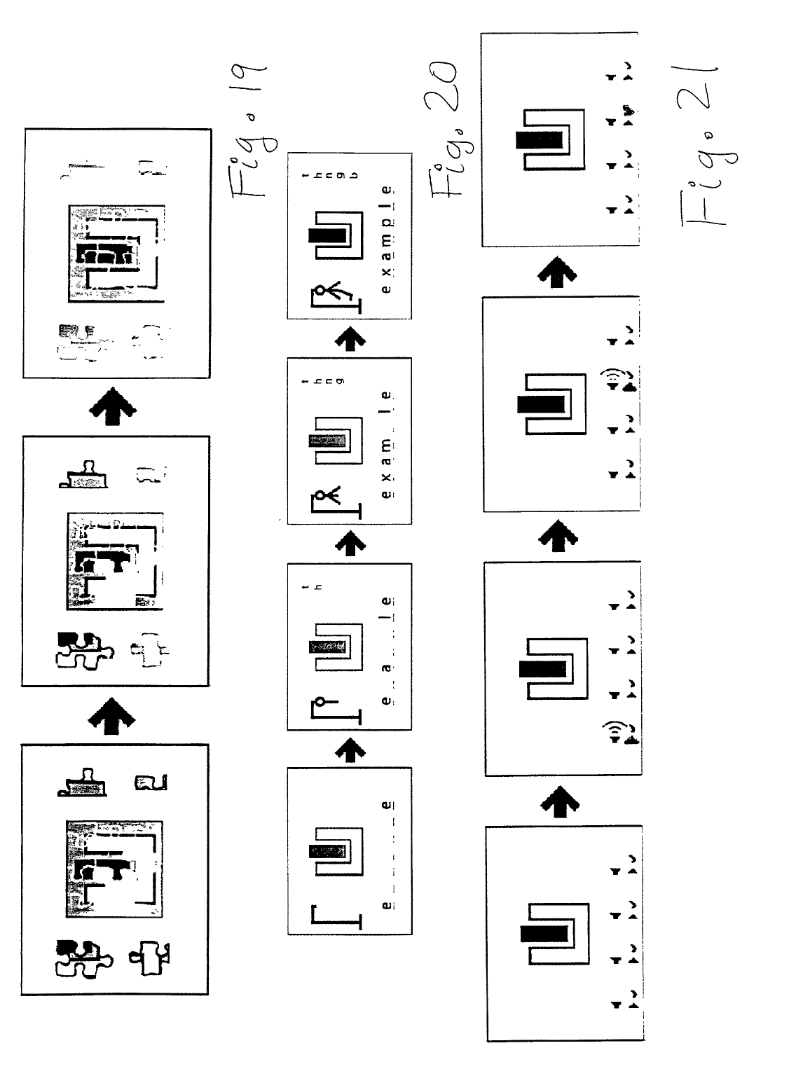

The banner advertisement that appears in step 270 may of course take a variety of forms, including banner advertisements in multimedia format. Additional examples of banner advertisements are illustrated in FIGS. 14-21. In the banner advertisement illustrated in FIG. 14, a rotating logo is presented to the user, who must then select one of two arrow buttons to position the logo correctly, the position in the third frame being the correct answer that allows the user to earn credit and proceed. In the banner advertisement illustrated in FIG. 15, the user is required to use arrow keys or a mouse to move tiles around until the logo is formed, while in the banner advertisement illustrated in FIG. 16, the user must select from among a plurality of alternative shapes in order to complete the logo, and in the banner advertisements illustrated in FIGS. 17 and 18, the user must draw a missing piece of the logo, or the entire logo, by driving a cursor along a dotted pattern using an appropriate input device. In the banner advertisement illustrated in FIG. 18, the user must move around puzzle pieces until the logo is formed, and in the banner advertisement illustrated in FIG. 19, the user must play a game of “hangman” and select letters to form a brand name or brand slogan without getting hung. Finally, in the banner advertisement illustrated in FIG. 20, the user must select from among multiple icons that play different tunes in order to select the tune associated with a particular product, service, or company.

In the illustrated example, once display of the interactive advertisements begins, the “exit” button is removed, leaving the user without an option of terminating the display without terminating the browser or communications program. The user must input an answer, view the user's credit account through button 40, or exit the browser entirely. It is of course within the scope of the invention, however, to permit the user to exit the advertisement and return to the browser without terminating it. Once the user responds by selecting one of the answer menu options (step 280), the response is sent to the advertisement server for evaluation, or possibly evaluated locally by the client software itself. If the user has responded appropriately as determined at step 290, then the server updates an account set up for the user with an appropriate numbers of credits (step 300). If the number of credits does not exceed that necessary to view the site, as determined at step 310, then another advertisement is displayed (step 270). Otherwise, the user is permitted to access the service (step 320), either by simply removing the banner advertisement, connecting to an appropriate server, or otherwise permitting access to the service or content.

Additional optional features of the invention include provision for the ability to click-through from the banner ad directly to the electronic address of the advertiser rather than the originally intended electronic address, the ability to store ads or their respective links in a favorites folder, and the ability to give users the choice to defer viewing ads for a subsequent moment and thus complete the transaction at a later time when credit for viewing the ad will be passed on to the user, or to accumulate credits in advance by viewing ads in blocks before seeking access to an electronic address, service, or content to which the credits will apply. Such a system would not only permit the user to determine credit usage, but also allow a user preference file to be collected that can be used by multiple services or sites. In that case, users may also be afforded the opportunity to by-pass use of the system and method with respect to certain destinations so as to avoid having to view banner advertisements in favor of direct access.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A method for ensuring that a user acknowledges an advertisement in exchange for access to an electronic address, service, or content, comprising the steps of:
presenting an interactive banner advertisement to the user when said user indicates a desire to access said address, service, or content,
upon presentation of the interactive banner advertisement, permitting access to the address, service, or content only if the user submits an appropriate reply to the interactive banner advertisement.

2. A method as claimed in claim 1, wherein said electronic address, service, or content is an Internet uniform resource locator.

3. A method as claimed in claim 1, wherein said electronic address, service, or content is content provided by a server connected to the Internet.

4. A method as claimed in claim 1, wherein said electronic address, service, or content provided by a broadcaster on an interactive digital television network.

5. A method as claimed in claim 1, wherein said electronic address, service, or content is a service provided over a wireless network.

6. A method as claimed in claim 5, wherein said wireless network is a cellular network.

7. A method as claimed in claim 1, wherein client software connects said user's computing device to a proxy server, and wherein said proxy server carries out said steps of presenting said interactive banner advertisement and permitting access to said service only if the user submits an appropriate reply to the banner advertisement.

8. A method as claimed in claim 7, wherein a provider of the electronic address, service, or content downloads said client software to the user's computing device when said user requests access to said electronic address, service, or content.

9. A method as claimed in claim 8, wherein said client software is resident on said user's computing device before said user requests access to said electronic address, service, or content.

10. A method as claimed in claim 8, wherein said client software is resident on a server located at or that provides the electronic address, service, or content.

11. A method as claimed in claim 1, wherein client software connects said user's computing device to a server located at or that provides said electronic address, service, or content, and wherein said server carries out said steps of presenting said interactive banner advertisement and permitting access to said electronic address, service, or content.

12. A method as claimed in claim 11, wherein said client software is a plug-in to an Internet browser installed on said user's computing device.

13. A method as claimed in claim 12, wherein said plug-in is downloaded to the user's computing device when said user requests access to said electronic address, service, or content as a pre-requisite to gaining access to said electronic address, service, or content.

14. A method as claimed in claim 11, wherein said electronic address, service, or content is a subscription-based service.

15. A method as claimed in claim 14, further comprising the steps of identifying said user and determining whether said user has a subscription to said service, and wherein said step of presenting said interactive banner advertisement is carried out if said user does not have a subscription to said service.

16. A method as claimed in claim 15, further comprising the steps of tallying credits each time the user responds correctly to an interactive banner advertisement, and of carrying out said step of presenting said interactive banner advertisement only if said user does not have a subscription to said service and said user further does not have a predetermined number of said credits.

17. A method as claimed in claim 1, further comprising the step of tallying credits each time the user responds correctly to an interactive banner advertisement.

18. A method as claimed in claim 17, further comprising the step of applying said credits against a subscription to said electronic address, service, or content.

19. A method as claimed in claim 1, wherein said interactive banner advertisements are selected based on information stored on said user's computing device and information provided by said user.

20. A method as claimed in claim 19, wherein said information stored on said user's computing device is in the form of cookies.

21. A system for ensuring that a user acknowledges an advertisement in exchange for access to an electronic address, service, or content, comprising:
a computing or communications device of said user, said computing or communications device being connected to a provider of said address, service, or content, over a data communications network;
software arranged to be loaded onto said computing or communications device and arranged to participate in presentation of an interactive banner advertisement to the user when said user indicates a desire to access said address, service, or content,
wherein, upon presentation of the interactive banner advertisement, said user is permitted access to the address, service, or content only if the user submits an appropriate reply to the interactive banner advertisement.

22. A system as claimed in claim 21, wherein said network is the Internet.

23. A system as claimed in claim 21, wherein said network is a wireless network;

24. A system as claimed in claim 21, wherein said network is an interactive digital television network.

25. A system as claimed in claim 21, wherein said software connects said user's computing device to a proxy server, and wherein said proxy server carries out said steps of presenting said interactive banner advertisement and permitting access to said service only if the user submits an appropriate reply to the banner advertisement.

26. A system as claimed in claim 25, wherein a provider of the electronic address, service, or content downloads said software to the user's computing device when said user requests access to said electronic address, service, or content.

27. A system as claimed in claim 21, wherein said software is resident on said user's computing or communications device before said user requests access to said electronic address, service, or content.

28. A system as claimed in claim 21, wherein said software is resident on a server located at or that provides the electronic address, service, or content.

29. A system as claimed in claim 21, wherein said software connects said user's computing or communications device to a server located at or that provides said electronic address, service, or content, and wherein said server is arranged to present said interactive banner advertisement and permit access to said electronic address, service, or content.

30. A system as claimed in claim 29, wherein said software is a plug-in to an Internet browser installed on said user's computing device.

31. A system as claimed in claim 30, wherein said plug-in is downloaded to the user's computing device when said user requests access to said electronic address, service, or content as a pre-requisite to gaining access to said electronic address, service, or content.

32. A system as claimed in claim 21, wherein said electronic address, service, or content is a subscription-based service.

33. A system as claimed in claim 21, further including means for tallying credits each time the user responds correctly to an interactive banner advertisement.

34. A system as claimed in claim 33, further comprising means for applying said credits against a subscription to said electronic address, service, or content.

35. A system for ensuring that a user acknowledges an advertisement in exchange for access to an electronic address, service, or content, comprising:
a computing device arranged to be connected to a computing or communications device of said user over a data communications network, said computing device being arranged to present an interactive banner advertisement to the user when said user indicates a desire to access said address, service, or content,
said computing device further being arranged to permit access to the address, service, or content only if the user submits an appropriate reply to the interactive banner advertisement.

36. A system as claimed in claim 35, wherein said network is the Internet.

37. A system as claimed in claim 35, wherein said network is a wireless network;

38. A system as claimed in claim 35, wherein said network is an interactive digital television network.

39. A system as claimed in claim 35, wherein said electronic address, service, or content is a subscription-based service.

40. A system as claimed in claim 35, further including means for tallying credits each time the user responds correctly to an interactive banner advertisement.

41. A system as claimed in claim 40, further comprising means for applying said credits against a subscription to said electronic address, service, or content.

42. A banner advertisement, comprising:
promotional text arranged in a box on a display screen of a computing or communications device and presented when a user of the computing or communications device requests access to an electronic address, service, or content over a network; and
area associated with said box for permitting entry of a response to said text,
wherein said banner advertisement prevents access to said electronic address, service, or content unless said response to said text is entered by the user.

43. An advertisement as claimed in claim 42, wherein said network is the Internet.

44. An advertisement as claimed in claim 43, wherein said area includes a pop-up menu.

45. An advertisement as claimed in claim 43, further comprising a hyperlink to a website of said advertiser.

46. An advertisement as claimed in claim 43, wherein said banner advertisement is in a multimedia format.

47. An advertisement as claimed in claim 46, wherein said banner advertisement further includes sounds.

48. An advertisement as claimed in claim 43, wherein said network is a wireless network.

49. An advertisement as claimed in claim 43, wherein said network is an interactive digital television network.
